(19) United States
(12) Patent Application Publication
(10) Pub. No.: US 2011/0104502 A1
(43) Pub. Date: May 5, 2011

(54) Application of the Organic and/or Inorganic Refinishing of the Internal Face of the Exterior Glass of Oven's Door

(76) Inventors: Maria de los Angeles Calixto Martinez, Queretaro (MX); Francisco Benito Anton Gabelich, Queretaro (MX)

(21) Appl. No.: 12/731,475

(22) Filed: Mar. 25, 2010

(30) Foreign Application Priority Data
Apr. 2, 2009 (MX) MA/A/2009/003573

(51) Int. Cl. B32B 17/06; B05D 3/10

(52) U.S. Cl. 428/429; 427/299

(57) ABSTRACT

A method and apparatus to enable to take place the method and where said method is to deposit a dimethyl based paint on the face of a glass sheet, laminate or plate to be used in an electric household appliance which includes the steps to deposit a dimethyl siloxane based paint on the exposed surface of the glass sheet, laminate or plate, forming a coat of said paint over said glass; pre-curing the glass sheet, laminate or plate and the dimethyl siloxane based paint in a primary oven and curing the glass sheet, laminate or plate and the dimethyl siloxane based paint in a secondary oven. The apparatus consists of separate distinct stations in order for the process to take place.

### RELATED APPLICATIONS

This application claims priority from Mexican application Serial No. MX/a/2009/003573 filed Apr. 2, 2009, which is incorporated herein by reference in its entirety.

### FIELD OF INVENTION

The present invention refers to a method and an apparatus used to deposit organic paint on the face of a plate, laminate or pane of glass, more specifically, the depositing of a dimethyl siloxane based paint on the surface of the exposed face of electric household appliances and its cures.

### BACKGROUND

Various efforts have been made to attempt to provide a process for the refinishing of glass, which, far from being simple, inexpensive and energy efficient with respect to known art, do not provide volatile chemicals, are not detrimental to the environment; they are complex and energy inefficient. Generally, the known art processes do not give the glass a refinish which increases its resistance, without being subjected to high temperatures which could cause deformation of the glass and where said refinish could be removed without damage to the glass should the refinish not be adequate, in addition to which said refinish can yield a wide array of solid and metallic colors, withstand scratches, as well as high temperatures of operation. Specifically, high temperatures are considered, as one of the applications for which this process was originally conceived was for the decoration on the glass of domestic ovens, dryers and stoves. However, it should be noted, that this process can be applied to any type of domestic appliance.

The process which is most commonly used currently to decorate glass on stove doors or oven hoods as well as domestic clothes dryers, uses ceramic paint, which involves a refinishing which utilizes a base of salicylic oxide which adheres to the substrate in this case silicate sodium calcium glass at temperatures which vary between 600 and 700° C. (1100 and 1290° F.). This ceramic paint, can generally, contain lead, cadmium and selenium. For example, the yellow and red colors have oxides which in order to attain their color have a lead base, one part selenium oxide and another part cadmium oxide, additionally, in order to attain metallic colors at least two layers of ceramic paint are required as a base, which increases cost and creates a less desirable appearance. Furthermore, the elements generally contained in ceramic paint, such as lead, selenium and cadmium are harmful and toxic, and when heated to high temperatures, they free radicals and form compounds which could come into contact with food, given the high temperatures of the ovens (above 400° C. (752° F.)).

The formulas of these ceramic pastes and porcelain enamel contain clay particles in order to give form to the refinish. When these clay particles do not eliminate the water contained within them completely, they cause the formation of a bubble structure (gas trapped in the interface of the refinish-substrate) which due to the heating and cooling function, said bubbles gather and form a crack on the enamel and thus create a defective refinish; not a pleasant sight.

Various efforts have been made through the years towards the adherence to glass techniques, some of them being successful in the architecture area or coating as is the case in the document U.S. Pat. No. 5,510,188 by Larry Vockler, which describes a method to recover glass with a refinish which resembles a ceramic refinish. For this process, high temperatures are needed, since the coating is composed of sodium silicates, colloidal silicates, pigments and feldspar. Specifically, all of these ingredients are mixed in a solution to form a paste which is applied on the glass at least twice, with the first stage involving a drying or pre-curing process at a temperature which varies between 200 and 300° C. (392 and 572° F.). Later, a sintered or cured process is preformed whose temperatures vary between 500 and 715° C. (932 and 1320° F.). As can be observed, the temperatures reached are very high and special equipment is required which can withstand and control with precision such high temperatures and the high consumption of energy.

Another effort can be found described in Gabriele Roemer Scheuermann et al's document U.S. Pat. No. 7,361,405 which uses an organic/inorganic flux which does not cause a reaction on the glass substrate over which the refinish structure is applied: yet as this process does not create a reaction which anchors to the refinish, friction from everyday use as well as high temperatures to which the appliance is subjected to, will cause said refinish to detach.

It is in this way that the present invention suggests a process which is simple, inexpensive, and environmentally friendly, with possibilities for recycling which ensue the above mentioned inconveniences.

### BRIEF DESCRIPTION OF THE INVENTION

Oven and stove doors have evolved with the passage of time, as they were originally made of cast iron with no window through which the interior of the oven could be seen. Years later a stamped steel structure with an inlay which allowed for the placement of a packet of parallel glass which permitted the user a view into the oven's interior, thus technology has evolved to the point of where different ovens and stoves now showcase panoramic doors which allow a better look into the cavity's interior.

However, previous panoramic oven door designs were made with coated steel with some type of paint which could withstand high temperatures or with ceramics such as pewter. The production processes for these types of doors were complicated, with a high quantity of pieces being rejected (and these pieces were difficult to recycle), as well as very large and highly specialized equipment being necessary which would be capable of reaching very high temperatures, and additionally consume a high quantity of energy. For these and other reasons, glass designs have become very popular among manufacturers of electric household appliances, as it allows for resistant doors which isolate heat and the temperatures generated inside the oven's cavity with a simple design, few pieces and aesthetically pleasing. This highlights the importance of encasing sheets or glass plates adequately, due to the temperature range which an oven's door must withstand. The process most often chosen by manufacturers is that of fried ceramic, and this process implies the use of high temperatures (around 600° C. (1110° F.)), as well as the process being prone to generate volatile organic compounds (VOCs) coupled with the use of cadmium and lead among others to obtain the desired colors and required resistance. On the other hand, said process used for glass decoration can free molecules or free radicals of a compound when the oven's cavity reaches its working temperature. The array of colors is also a limiting factor, the palette of colors of fried ceramic being limited by the type of compounds which are used as pigments to obtain the desired color; for example the colors red, orange and yellow contain cadmium and selenium based pigments. Cadmium and selenium are considered elements which are harmful to health, and the use of these colors is allowed only on the exterior of pots, pans and cooking utensils but never on the area which comes into contact with food. Some yellow pigments may contain the presence of lead. This coupled with the refinish that is performed on the glass' cover, which is rigid and does not add mechanical resistance to the glass plate. It is also worth mentioning that the recycling process also becomes difficult, the refinish being such that it is impossible to remove either mechanically or chemically, so that the glass along with the refinish must be melted leaving as an only option the stripping of slag once the glass is melted. Therefore, the need to find a simple, inexpensive, low-energy process, which is environmentally friendly and which requires low temperatures so that cooling down times are reduced or null, as well as allows for mechanical or chemical stripping and yet, which will provide the glass a refinish which will allow it to withstand the high temperatures at which it shall be submitted to and allows for improvement of the mechanical characteristics of the glass, coupled with the ability to offer the manufacturer a wide palette of colors, without the need to resort to pigments which are harmful or toxic to health or environment.

Thus, it is the goal of the present invention to achieve in one single process all of the above.

Therefore, the process of the present invention is comprised of the following steps:
(a) Cleaning—the sheets or glass plates are subjected to cleaning preferably with a base of D-Limonene which is a natural substance extracted from citric, being the principal component of the citric cortex: D-Limonene can be mixed with a surfactant to dissolve in water or in a rinsing solution and therefore this compound does not leave toxic residues, it is bio-degradable, an excellent oil remover and makes grease soluble.
(b) Drying—is achieved by the use of air blowers, run-off or thermal radiation which cause evaporation and/or the elimination of water on the glass' surface caused by step (a).
(c) Application of the first paint coat using screen painting by means of a nylon mesh system which employs fabric which is approximately anywhere from 80 mesh to 156 mesh.
(d) Drying and Pre-curing—The already refinished sheet or plate of glass is subjected to an oven which must be capable of reaching superficial glass temperatures between 110 and 180° C. (230 and 356° F.) for a period of time varying from one to six minutes, achieving during this stage water evaporation on the paint coat, coupled with a reaction zone where the reaction of salicylic oxide of the glass and that of the paint's siloxane shall take place.
(e) Application of the second coat of paint—optional step. A second coat of paint by means of screen painting using a similar mesh to the one described in (c) is applied.
(f) Curing—this new immersion of the sheet or plate of glass to heat, takes place at a medium temperature, with the purpose being that its superficial temperature reach between 140 and 250° C. (284 and 482° C.), for a period of time between one to six minutes, and it is during this step that the chemical reaction of the glass silicate with the siloxane of the paint takes place, which creates an anchor to the glass, and knowing that the film is also cured due to the polymer links engaging in a intercrossing or reticulation reaction, forming a film with a thickness of 0.0508 to 0.102 mm (0.002 to 0.00402 in) on the exposed surface of the paint on the glass sheet or plate.
(g) Cooling down and packaging—Since the temperatures which the sheet or plate of glass reaches are medium temperatures, it is not necessary to have long cooling down periods before handling the glass sheets for their packaging or disposition, knowing that thick cotton gloves should suffice in an operator's ability to handle the painted glass sheets or plates, and yet between 4 to 7 minutes are recommended to allow the chemical reactions to take place and allow for the cooling down of the glass sheets or plates.

### BRIEF DESCRIPTION OF THE DRAWINGS

The particular characteristics and advantages of the invention, as well as other objects of the invention, will become apparent with the following description, taken in connection with the accompanying figures which:

FIG. 1 is an isometric view of the first stretch of the roller bed, on which the sheets or plates of glass are placed.

FIG. 2 is a schematic front view in cross section of the principal parts of the cleaning station.

FIG. 3 is an isometric view of a scrubbing roller.

FIG. 4 is a schematic front view in cross section of the principal parts of the drying station.

FIG. 5 is an isometric view of a screen painting machine.

FIG. 6 is a schematic view of a primary oven.

FIG. 7 is a schematic view of a secondary oven.

### DETAILED DESCRIPTION OF THE INVENTION

The required paint for process of the present invention is composed of a polyvinylsiloxane with liquid silicon. Said components, upon contact with heat at temperatures varying between 110 and 180° C. (230 and 356° F.), preferably between 140 and 180° C. (284 and 356° F.), and even more preferably between 150 and 160° C. (302 and 320° F.), for a time varying between 1 and 6 minutes, preferably between 1 and 4 minutes average, preferably in an infrared oven, create two main processes, the first of which is a reticulation or intercrossing, to form a stable refinish, with good temperature resistance, water repellent, stable to infrared light as well as to exposure, amongst other characteristics. The second process is to prepare the anchor to the glass zone, to enable the silicon contained in the paint to react to the glass.

The above mentioned paint contains five basic compounds which are detailed as follows:

The polivinylsiloxane with liquid silicon is formed by two parts identified as part A and part B.

Part A is composed of:
I. Dimethylvinyl which upon reaction forms a dimethylsiloxane;
II. Dimethylvinyl and trimethyl silica;
III. Dimethylvinyl which forms a dimethyl and a methylvinyl siloxane:
IV. A platinum catalyst.
   Part B is composed of:
V. Dimethylvinyl which is transformed into dimethylsiloxane
VI. Dimethyvinyl-dimethyl-methylvinyl siloxane

Upon mixing part A with part B, this mixture represents about 75% to 90% in weight of the paint; additionally about 1% in weight of a platinum based or methyl hydrogen siloxane and methyl hydrogen cyclosiloxane with a silane hydride catalyst is added to accelerate the reticulation or intercrossing reaction, as well as to prepare the anchor zone which will give the paint the correct adhesiveness to the glass.

One of the components which are created both in part A as well as in part B is dimethylsiloxane, a polymer which has been used with great frequency in the production of flexible molds, it is the poly(dimethylsiloxane) known technically as PDMS. This polymer is highly hydrophobic, has high optic transparency and good mechanical properties, as well as being highly elastic with good memory, such that if submitted to external force, once the force is removed, it tends to revert to its original form: its chemical formula is:

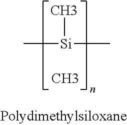

It is worth mentioning the presence of an organic compound which contains several vinyl groups (—CH═CH2), named vinyl. This is derived from ethane CH2=CH2. The vinyl has the ability to substitute the hydrogen for another functional group.

In general, glass is a product made of inorganic materials which are optically transparent, which can be cooled down into a rigid state without crystallizing: the glass to be decorated is a sodium calcium silicate which has the following chemical composition:

| | |
|---|---|
| Silica material (SiO2) vitrifier from | 69 to 74% |
| Sodium Oxide (Na2O) flux from | 12 to 16% |
| Calcium Oxide (caO) stabilizer from | 5 to 12% |
| Magnesium Oxide (MgO) from | 0 to 6% |
| Aluminium Oxide (AL2O3) from | 0 to 3%. |

The most common type of glass is glass made of sodium and lime which can be made from: silica sand, sodic ash and limestone rock, in such proportions that the glass has a composition which nears Na2O—CaO-6SiO2; and the addition of increasing quantities of Na2O (sodium oxide) lowers fusion temperature and the softening of glass, which also causes it to lower its resistance to chemical attacks. In excess of Na2O (sodium oxide) the glass can become water soluble and is known as aqueous glass, so adding lime with Na2O, creates a glass less soluble to water which additionally has less tendency to react with other elements or chemical compounds, increasing its hardness since lime (calcium oxide—CaO) plays an important role in the crystallization of the molecules in order to crystallize. If this occurs, the atoms will line up into regular structures, which do not allow for light to shine through them, making the glass opaque. In modern glass made of sodium and lime, part or all of the lime can be replaced by other alkaline oxides found on earth and part or all of the sodium with K2O. The glass gets its color in large part thanks to the presence of metallic ions, for example, green glass contains iron oxide (III), Fe2O3 or copper oxide (II) CuO, silicon oxide has a tetrahedral structure (SiO4) making the glass highly fire resistant in enamels, allowing for a wider range of casting temperatures, chemical resistance, high viscosity and shine with a low thermal expansion coefficient.

After having described the chemical nature of the components in paint as well as those of glass which serve as a reference for better understanding of the process of the present invention which is described as follows:

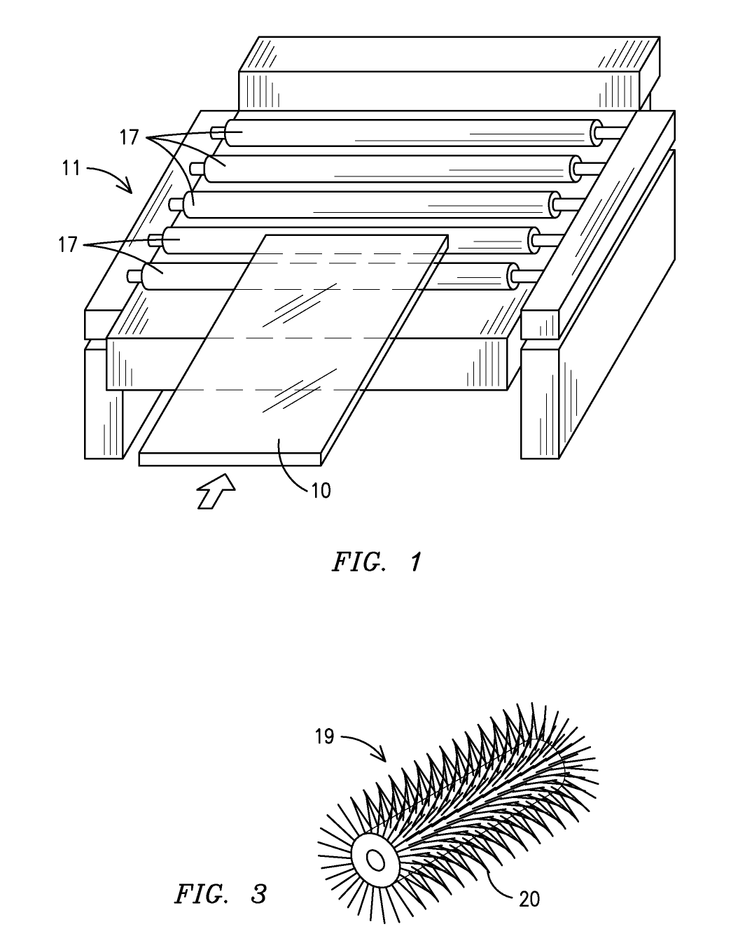

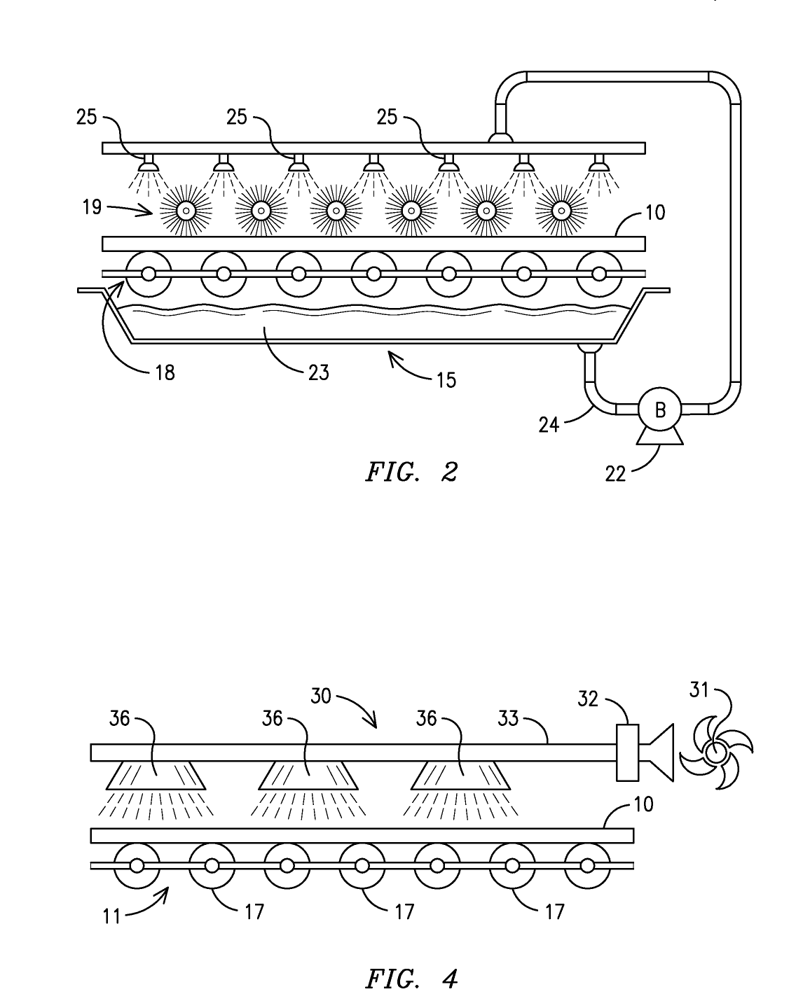

In the preferred modality of the invention, FIG. 1 shows a schematic sample of the rollers 11 with a plurality of rollers 17 which shall transport the glass sheet or plate 10 as it travels along the decorating process, objective of the present invention. After having placed the sheet, laminate or plate of glass 10 on the roller bed 11, said rollers 17 shall transport said glass laminate or sheet 10 to the cleaning station 15 shown in FIG. 2, where dust, particles or grease which can interfere with the adherence of paint to the sheet, laminate or plate shall be removed 10. Thus the cleaning is performed preferably by a washer 16 with horizontally placed rubber rollers 17 which move the glass plate, laminate or sheet 10 to a damp zone, where there are two sets of horizontal rollers 18, 19, one set of which is deemed the inferior set 18, which serve to hold and move the glass plate, laminate or sheet along 10, and the other set of rollers deemed the superior 19 as shown in FIG. 3 is found parallel to the inferior rollers and are preferably covered by a scrubbing medium 20, such as bristles, fibers, scrapers, sanders or scrubbers etc. which along with a spraying system 25, 23, 24, 22 involves a pump 22 as well as a tank 23, in where said tank 23, the mixing of degreaser 26 or detergent with a D-limonene base with water at room temperature occurs, as well as involving a set of ducts 24 made by hoses or tubes which transport the cleaning agent into tubs 25 which are placed above the superior rollers, uniformly spraying the superior rollers 19 which are located there and they in turn cause friction with the aid of their scrubbing mechanism 20 on the exposed surface of the glass plate, laminate or sheet 10. It is worth mentioning that said rollers are coupled to a motor, which can be electric, hydraulic or pneumatic among others, but said motor is mechanically coupled to the bristles 17, 18, 19 either via a coupling or by some type of transmission such as a system of bands and pulleys or sprockets and chains or by some form of speed reducer. Said motor is preferably controlled electronically, an option of which could be a PLC (Programmable Logic Controller), a system controlled by a computer, driver etc. Said control system controls the on and off functions of the pump 22 as well as the cleaning detergent's level contained in the tank 23 allowing a valve to open for water flow into its interior or have the ability to ring an alarm for the operator to add or replace or restitute the proper levels of the cleaning detergent.

Next, the glass plate, laminate or sheet 10, moves along the mechanized roller bed 11 and reaches a drying station 30 as is shown in FIG. 4 where excess water or residual detergent is removed, preferably by fans 31 which affect a current of air on the surface of the glass or by means of heat which evaporates the residual detergent. Worth noting that if using fans 31, these should suck the air which will force them through a duct 33 which shall drive them to the diffusers 36 which shall direct the air to have an impact on the surface of the exposed glass sheet, laminate or plate 10. Somewhere along the track of the referred to ducts 33, there is a filtering medium 32, which traps impurities, particles, grease or any other undesirable particle which might be contained in air, with the object of preventing the contamination of the glass sheet, laminate or plate 10 which is clean. At the end of the drying stage there is a break on the mechanical roller bed 11, and it is at this point that an operator removes the glass which is rolling from the drying station 30 to mount them on carts which contain a magazine where the glass plates, laminates or sheets are carefully placed.

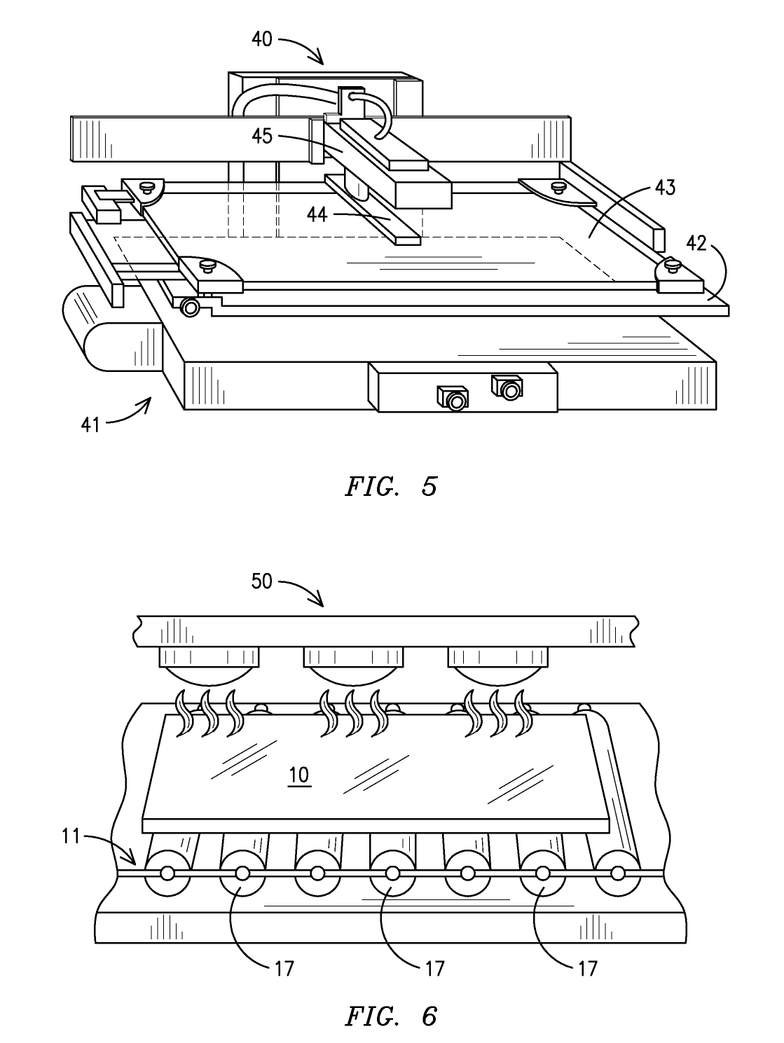

The cart 34 loaded with the clean glass plates, laminates or sheets is moved to the painting station 40, where an operator removes the glass plates, laminates or sheets 10 to subject them to the screen printing machine 41 shown in FIG. 5. The operator places the glass plate, laminate or sheet on the table 42 fastening to said table with fasteners, the screen which has a nylon mesh between 86 mesh and 156 mesh is then lowered 43. Said mesh is already covered on its surface in those areas through which no flow of paint will be allowed, being permeable only in pre-determined areas.

The paint should have a viscosity between 30'000 and 35'000 cps (with spindle No. 6 at 10 rpm at 22° C. (71.6° F.)), and a relative density of 1.04 to 1.20 coupled with particle density of 10 to 12 microns of titanium oxide.

The paint is automatically dosed by the screen printing machine 41 over the screen 43, the dosing device pushed by the head 45, pulls a mass of paint and spreads the paint over the screen 43 causing the paint to permeate that area which is permeable and thus is deposited over the exposed surface of the glass plate, sheet or laminate 10. The screen is raised 43, the glass plate, sheet or laminate 10 is removed from the table 42, placing it again on the mechanized roller bed 11, which will move the glass plate, sheet or laminate 10 into the primary oven 50.

The primary oven 50, as is clear in FIG. 6, preferably uses infrared as heating means, but can also use other technologies such as: ultraviolet and electric resistance among others. The above mentioned primary oven 50 can be enabled onto the mechanized roller bed in tunnel form, so that the glass plate, sheet or laminate 10 which is transported by the same mechanized roller bed 11 can travel in the interior of said primary oven 50, whose surface is found parallel above the mechanized roller bed 11. It is on this parallel superior surface that a series of infrared emitters are placed which aid in elevating the temperature of the glass plate, sheet or laminate 10 to a temperature varying between 140 and 189° C. (284 to 372° F.), preferably between 150 and 160° C. (302 to 320° F.) for a total exposure time varying between 1 and 4 minutes. It is during this phase when a reaction between the paint and the area on which the paint is placed on the glass plate, sheet or laminate 10 takes place, this reaction being a hydrosilylation expressed in the following terms in formula I:

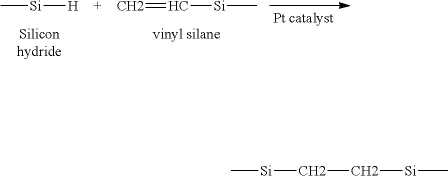

The glass plate, sheet or laminate's 10 composition (silicon hydride) with the vinyl silane of the paint, upon contact with a platinum based catalyst, exposed to heat, creates one of the primary reactions of the anchoring process and generates secondary reactions producing an ethyl silane compound; the secondary reactions help reticulate the silane hydride contained in the paint creating a catalyzed hydrolysis with hydride silane groups and water as is shown in the following formula II:

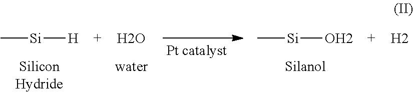

This recently formed from the catalyzed reaction silanol group, will react with the silicon hydride group (—Si—H—) to form a type of reticulation Si—O—Si, being created according to the following formula III:

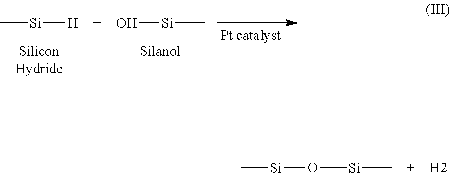

Another secondary reaction is that of condensation with the two silanol groups formed in reaction IV. This takes place during the curing process.

In an alternative modality of the invention a second screen printing station could occur, this step would depend upon the complexity of the desired decorativeness on the exposed surface of the glass plate, sheet or laminate 10 or in particular for white shades. It is worth noting that the glass plate, sheet or laminate 10 shall attain a temperature lesser than 50° C. (122° F.), so that it may be subjected to a second coat of paint, and for this purpose, a cooling station which operates with forced air similar to that of the cleaning station 15 described above or a waiting station so that the glass sheet, laminate or plate's 10 temperature is lowered.

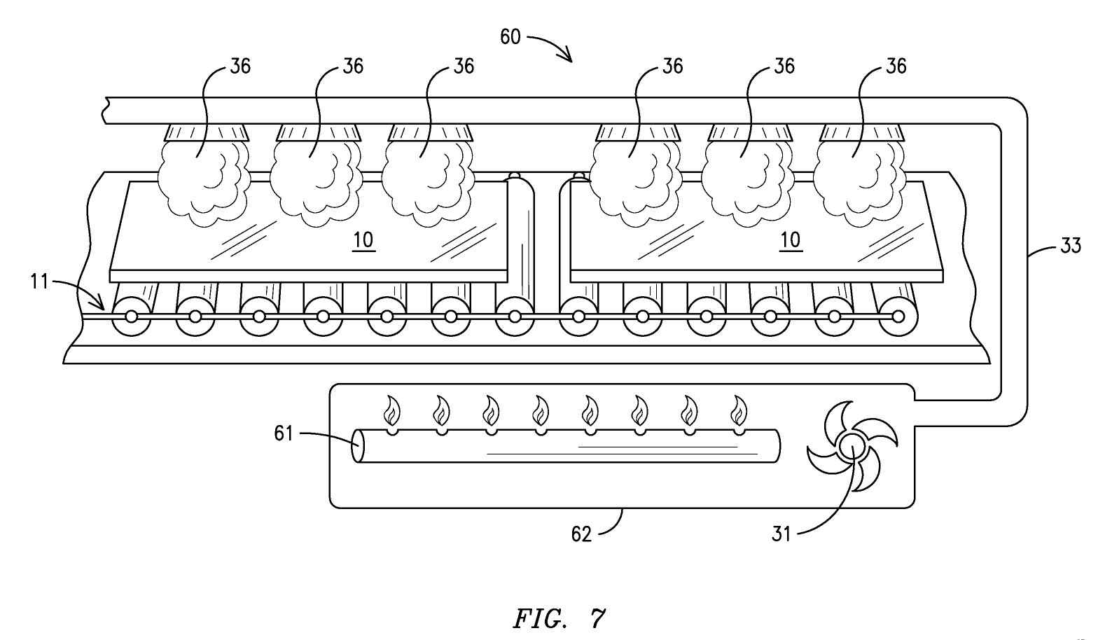

Following the preferred modality of the invention, the mechanized roller bed 11 is placed in the interior of a secondary oven 60, which is preferably a convection-type oven such as is shown in FIG. 7 which has gas burners 61 contained in a combustion chamber which heat the air creating a mixture of superhot gases resulting from air combustion at room temperature. Said mixture is conducted via ducts 33 to diffusers 36, which then direct said mixture to impact the exposed surface of the glass sheet, laminate or plate 10, achieving in this way the superficial temperature of the glass sheet, laminate or plate 10 to vary between 140 and 250° C. (284 and 482° F.), and preferably a range between 150 and 200° C. (302 and 392° F.) as the glass remains in the oven for a period of time from 1 to 6 minutes and preferably for 2 to 6 minutes.

In an alternative modality of the invention, the secondary oven can also be one of the following types; infrared, ultraviolet and electric resistance among others.

In this phase of the curing process it is important to note the condensation reaction which is characterized by the union of two molecules and the elimination of one molecule, which is generally water, as can be seen in the following formula, one molecule is the main component of the glass and the other is the liquid based silane as it is subjected to heat which causes condensation reaction IV and creates a strong compound S—O—Si, which is a very stable structure, and said reaction IV can be represented as follows:

—Si—OH+—OH—Si—→—Si—O—Si—+H2O (IV)

The reactions which are catalyzed by platinum are shown in formulas II and III, which are slow reactions as opposed to the primary reticulation reaction with formula I. The condensation reaction itself is slow in comparison to the SIH reaction in formulas II and III. Conversely, the reactions in formulas II and IV take place simultaneously ending the post-curing process.

Following the path of the mechanized roller bed 11, the glass sheet, laminate or plate 10 is subjected to a cooling process, which can be something as simple as lengthening the mechanized roller bed 11 or a waiting station where the glass sheet, laminate or plate 10 is placed for some time until it reaches a temperature lower than 50 degrees centigrade when it can be handled by the operators or by installing fans similar to those described in the cleaning station 25.

Having described the present invention with enough detail, it is found to be of an inventive level, novelty being evident in its industrial application taking into account that a person well-versed in this technique can implement the necessary changes to the process herein described, said changes being included in the protected spectrum of the following claims.

1. A method of depositing dimethyl siloxane based-paint on the surface of a glass sheet, laminate or plate to be used on a electric household appliance comprising:
depositing the dimethyl siloxane paint on the exposed surface of the glass sheet, laminate or plate, forming a coat of said paint over said glass;
pre-curing the glass sheet, laminate or plate and the dimethyl siloxane based paint in a primary oven; and
curing the glass sheet, laminate or plate and the dimethyl siloxane based paint in a secondary oven.

2. The method according to claim 1, wherein the method includes the additional step of cleaning with a liquid detergent the glass sheet, laminate or plate to remove impurities before the refinishing phase.

3. The method according to claim 2, where an additional step is that of drying the glass sheet, laminate or plate in order to remove the liquid detergent after said glass sheet, laminate or plate is washed.

4. The method according to claim 1, where the step of pre-curing in the primary oven the paint deposited which contains vinyl silane on the glass sheet, laminate or plate which upon contact with a platinum based catalyst increased heat generates a primary anchoring reaction and a secondary reaction which reticulates the silane hydride contained in the paint, thus creating a catalyzed hydrolysis, with silane hydride and water groups in the following reaction:

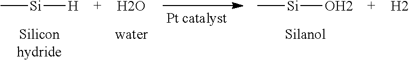

5. The method according to claim 4, where the recently formed silanol group formed in the reaction catalyzed by the remaining hydride silane group (—Si—H—), to form a type of reticulation Si—O—Si, being created by the following reaction III:

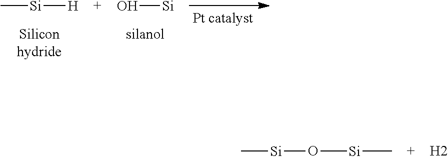

6. The method according to claim 5, where the step of curing the glass sheet, laminate or plate with said paint in said secondary oven takes place in a condensation reaction eliminating one water molecule and uniting one SiOH molecule from the glass sheet, laminate or plate and another OHSi molecule from the paint upon being submitted to heat forming an S—O—Si compound, said reaction being represented as follows:

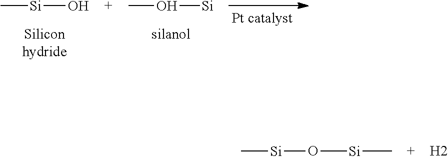

7. The method according to claim 2, where the washing detergent is a de-greaser.

8. The method according to claim 1, wherein the temperature of the primary oven varies between 140 and 180° C. (284 and 356° F.) preferably between 150 and 160° C. (302 and 320° F.) and the time of exposure varies between 1 and 4 minutes.

9. The method according to claim 1, wherein the temperature of the secondary oven varies between 150 and 200° C. (302 and 392° F.) and the time of exposure varies between 2 and 6 minutes.

10. The method according to claim 1, wherein the depositing step and that of pre-curing take place at least twice, so that between the first pre-curing step and the subsequent depositing step, there is a cooling down of the glass sheet, laminate or plate step so that the temperature is lowered to less than 50 degrees centigrade before the second step of depositing the dimethyl siloxane based paint on the exposed surface of the glass sheet, laminate or plate can take place which forms a second coat of said paint over said glass.

11. The method according to claim 10 in which the color is white or the shade is white.

12. A product formed based on the methods described in claims 1 through 11.
